(19) United States
(12) Patent Application Publication
(10) Pub. No.: US 2024/0155483 A1
(43) Pub. Date: May 9, 2024

(54) Method And Apparatus For Cell Selection During Device Collaboration

(71) Applicant: MediaTek Inc., Hsinchu City (TW)

(72) Inventors: Chun-Hao Fang, Hsinchu City (TW); Lung-Sheng Tsai, Hsinchu City (TW)

(21) Appl. No.: 18/241,971

(22) Filed: Sep. 4, 2023

Related U.S. Application Data
(60) Provisional application No. 63/382,733, filed on Nov. 8, 2022.

(51) Int. Cl. H04W 48/20; H04B 17/318

(52) U.S. Cl. CPC H04W 48/20; H04B 17/328

(57) ABSTRACT

Examples pertaining to a user equipment (UE) performing a cell selection during device collaboration with a wireless device are described. A UE receives a reference signal received power (RSRP) measurement result from the wireless device or from a network node of a wireless network. The RSRP measurement result includes a first list indicating at least one RSRP transmitted from at least one candidate cell to the wireless device. The UE perform a cell selection based on at least one of the first list and a second list. The second list indicates at least one RSRP transmitted from the at least one candidate cell to the apparatus. The UE determines a serving cell from the at last one candidate cell based on the cell selection.

### CROSS REFERENCE TO RELATED PATENT APPLICATION(S)

The present disclosure is part of a non-provisional application claiming the priority benefit of U.S. Patent Application No. 63/382,733, filed 8 Nov. 2022, the content of which herein being incorporated by reference in its entirety.

### TECHNICAL FIELD

The present disclosure is generally related to mobile communications and, more particularly, to a user equipment (UE) performing a cell selection during device collaboration with a wireless device.

### BACKGROUND

Unless otherwise indicated herein, approaches described in this section are not prior art to the claims listed below and are not admitted as prior art by inclusion in this section.

In conventional network of 3rd Generation Partnership Project (3GPP) 5G New Radio (NR), for enhancing the coverage of NR network communication, a wireless device (e.g., a repeater) may be introduced in the NR network. In particular, the wireless device with compatibility of legacy user equipment and lower cost of deployment may be deployed in the NR network for reflecting, amplifying and/or forwarding information from a base station (BS) to a UE and/or from a UE to a BS. When the UE determines to have a device collaboration with one corresponding wireless device, the UE may receive a data signal transmitted by the BS in a first component carrier (CC) and receive the data signal transmitted by the wireless device in a second CC. As that, the UE may be benefit from receiving the same data signal in the two CCs (e.g., the first CC and the second CC) to increase its rank (which may not be limited by its antenna port number) and to improve its throughput. However, during the device collaboration, an issue of inconsistent serving cell may occur because the UE and the wireless device may have different best serving cells for communication. If a reference signal received power (RSRP) of one serving cell for the wireless device is larger than the RSRP of another serving cell for the UE, an interference may happen to degrade the device collaboration between the UE and the wireless device. Therefore, there is a need to improve a cell selection for the UE during the device collaboration with a wireless device.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

One objective of the present disclosure is propose schemes, concepts, designs, systems, methods and apparatus pertaining to a UE performing a cell selection during device collaboration with a wireless device. It is believed that the above-described issue would be avoided or otherwise alleviated by implementing one or more of the proposed schemes described herein.

In one aspect, a method may involve a processor of an apparatus receiving an RSRP measurement result from a wireless device or from a wireless node of a wireless network. The RSRP measurement result may include a first list indicating at least one RSRP transmitted from at least one candidate cell to the wireless device. In response, the method may involve the processor performing a cell selection based on at least one of the first list and a second list. The second list may indicate at least one RSRP transmitted from the at least one candidate cell to the apparatus. The method may also involve the processor determining a serving cell from the at least one candidate call based on the cell selection.

In another aspect, a method may involve a processor of a wireless device determining an RSRP measurement result including a first list indicating at least one RSRP transmitted from at least one candidate cell to the wireless device. The method may also involve the processor transmitting the RSRP measurement result to an apparatus or to a wireless node of a wireless network before the apparatus performs a cell selection.

In another aspect, an apparatus implementable in a UE may include a transceiver and a processor coupled to the transceiver. The transceiver may be configured to communicate wirelessly. The processor may receive, via the transceiver, an RSRP measurement result from a wireless device or from a network node of a wireless network. The RSRP measurement result may include a first list indicating at least one RSRP transmitted from at least one candidate cell to the wireless device. In response, the processor may perform a cell selection based on at least one of the first list and a second list. The second list may indicate at least one RSRP transmitted from the at least one candidate cell to the apparatus. The processor may also determine a serving cell from the at least one candidate cell based on the cell selection.

It is noteworthy that, although description provided herein may be in the context of certain radio access technologies, networks and network topologies such as 5th Generation System (5GS) and 4G EPS mobile networking, the proposed concepts, schemes and any variation(s)/derivative(s) thereof may be implemented in, for and by other types of wireless and wired communication technologies, networks and network topologies such as, for example and without limitation, Ethernet, Universal Terrestrial Radio Access Network (UTRAN), E-UTRAN, Global System for Mobile communications (GSM), General Packet Radio Service (GPRS)/Enhanced Data rates for Global Evolution (EDGE) Radio Access Network (GERAN), Long-Term Evolution (LTE), LTE-Advanced, LTE-Advanced Pro, IoT, Industrial IoT (IIoT), Narrow Band Internet of Things (NB-IoT), and any future-developed networking technologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network scheme in accordance an implementation of the present disclosure.

FIG. 2 is a diagram of a proposed scheme for a UE determining a serving cell in accordance an implementation of the present disclosure.

FIG. 3 is a diagram of a proposed procedure during a handover for a wireless device in accordance an implementation of the present disclosure.

FIG. 4 is a diagram of a proposed procedure during a network-initiated handover for a UE in accordance an implementation of the present disclosure.

FIG. 5 is a diagram of a proposed procedure during a UE-initiated handover for a UE in accordance an implementation of the present disclosure.

FIG. 6 illustrates an example communication system having at least an example communication apparatus and an example network apparatus in accordance with an implementation of the present disclosure.

FIG. 7 illustrates an example process in accordance with an implementation of the present disclosure.

FIG. 8 illustrates another example process in accordance with an implementation of the present disclosure.

FIG. 9 illustrates another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to a UE performing a cell selection during device collaboration with a wireless device. According to the present disclosure, a number of possible solutions may be implemented separately or jointly. That is, although these possible solutions may be described below separately, two or more of these possible solutions may be implemented in one combination or another.

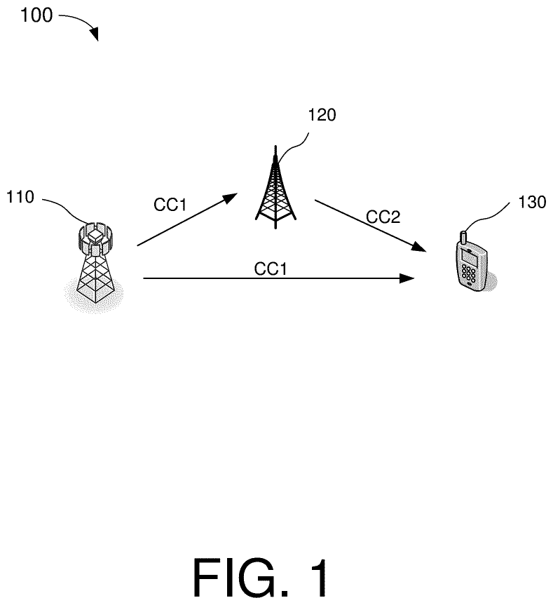

FIG. 1 is a diagram of an example network scheme 100 in accordance an implementation of the present disclosure. In some implementations, the network scheme 100 may include at least a BS 110 (e.g., eNB, gNB and/or transmission/reception point (TRP)), a wireless device 120 (e.g., a repeater 120) and a UE 130. Specifically, the wireless device 120 may reflect, amplify and/or forward an uplink/downlink (UL/DL) RF signal(s) between the BS 110 and the UE 130. When the UE 130 determines to have a device collaboration with the wireless device 120 via different component carriers (CCs), the UE 130 may receive a data signal transmitted by the BS 110 in a first CC (e.g., CC1) and receive the data signal transmitted by the wireless device 120 in a second CC (e.g., CC2). As that, the UE 130 may be benefit from receiving the same data signal in the two CCs (e.g., CC1 and CC2) to increase its rank, and the UE 130 may improve its capability that is not limited by an antenna port number and may improve its throughput.

During the device collaboration, an issue of inconsistent serving cell may occur because the UE 130 and the wireless device 120 may have different serving cells for communication, i.e., one serving cell with a maximum RSRP for the UE 130 may not be the best serving cell for the wireless device 120. In an event that an RSRP of a first serving cell (which is the best serving cell for the wireless device 120) selected by the wireless device 120 is larger than another RSRP of a second serving cell (which is the best serving cell for the UE 130) selected by the UE 130, an interference may happen to degrade the device collaboration between the UE 130 and the wireless device 120. Therefore, it is proposed to consider additional RSRP value(s) of the wireless device 120 before the UE performs its cell selection based on its own RSRP value(s) during the device collaboration with the wireless device, as described below. It is noteworthy that, while the various proposed schemes may be individually or separately described below, in actual implementations each of the proposed schemes may be utilized individually or separately. Alternatively, some or all of the proposed schemes may be utilized jointly.

In some implementations, it is assumed that at least one candidate cell may be configured to the UE 130 for supporting UE communications. In an event that the UE 130 is associated with the wireless device 120 for the device collaboration, the wireless device 120 may directly or indirectly transmit an RSRP measurement result to the UE 130 before the UE performs the cell selection based on its own RSRP measurement result, and the RSRP measurement result from the wireless device 120 may include a first list indicating at least one RSRP that is transmitted from the at least one candidate cell to the wireless device 120. In addition, the UE 130 may determine its own RSRP measurement result including a second list, and the second list may indicate at least one RSRP that is transmitted from the at least one candidate cell to the UE 130. As that, the UE 130 may consider the at least one of the first list as well as the second list to perform the cell selection, so as to determine a serving cell from the at least one candidate cell based on the cell selection.

In some implementations, in an event that the UE 130 directly receives the RSRP measurement result from the wireless device 120 via a dedicated signaling, the UE may adaptively select one cell from the at least one candidate cell as its serving cell based on the first list and/or the second list. Specifically, the UE 130 may select a first cell from the at least one candidate cell to be the serving cell, and the first cell may correspond to a maximum RSRP in the first list. Alternatively, the UE 130 may select a second cell from the at least one candidate cell to be the serving cell, and the second cell may correspond to a maximum RSRP in the second list. Alternatively, the UE 130 may select a third cell from the at least one candidate cell to be the serving cell, and the third cell may correspond to a maximum sum value in view of the first list and the second list. In one example, the UE may add one RSRP of one cell in the first list with another RSRP of the same cell in the second list, to obtain at least one sum value of a sum list in view of the first list as well as the second list, where the third cell may correspond to the maximum sum value in the sum list.

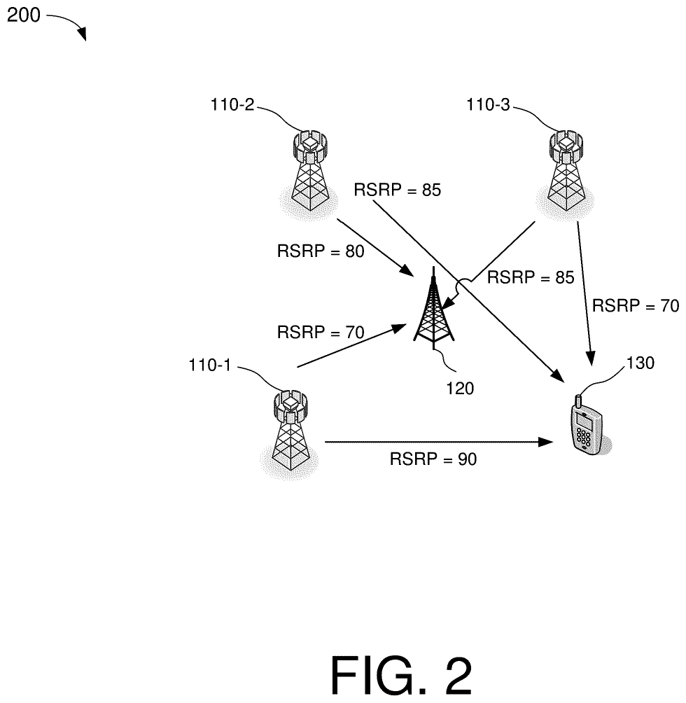

FIG. 2 is a diagram of a proposed scheme 200 for a UE determining a serving cell in accordance an implementation of the present disclosure. As shown in FIG. 2, there are three cells 110-1, 110-2 and 110-3 to be configured for serving the UE 130 and the wireless device 120. In one example, the UE 130 may determine the second list having a plurality of RSRPs transmitted from the cells 110-1, 110-2 and 110-3 to the UE 130 (e.g., 90 dBm, 85 dBm and 70 dBm), respectively. In addition, the wireless device 120 may determine the first list having a plurality of RSRPs transmitted from the cells 110-1, 110-2 and 110-3 to the wireless device 120 (e.g., 70 dBm, 80 dBm and 85 dBm), respectively. As that, based on the plurality of RSRPs in the first list (e.g., 70 dBm, 80 dBm and 85 dBm) and the plurality of RSRPs in the second list (e.g., 90 dBm, 85 dBm and 70 dBm) corresponding to the cells 110-1, 110-2 and 110-3, the UE 130 may select the cell 110-1 having a maximum RSRP value (90 dBm) as the serving cell in an event that the UE 130 only considers the second list. Alternatively, the UE 130 may select the cell 110-3 having a maximum RSRP value (85 dBm) in an event that the UE 130 only considers the first list. Alternatively, the UE 130 may select the cell 110-2 having a maximum sum value of RSRPs (85+80 dBm) in an event that the UE 130 both considers the first list and the second list.

In some implementations, the wireless device 120 may transmit the RSRP measurement result including the first list to the BS 110, and the BS 110 may forward the RSRP measurement result to the UE 130, i.e., the RSRP measurement result may be originated from the wireless device 120 to the UE 130. In other words, an indirect link is proposed for the wireless device 120 to transmit the RSRP measurement result to the UE 130 via the BS 110, and the UE 130 may receive the RSRP measurement result including the first list from the BS 110 before performing the cell selection.

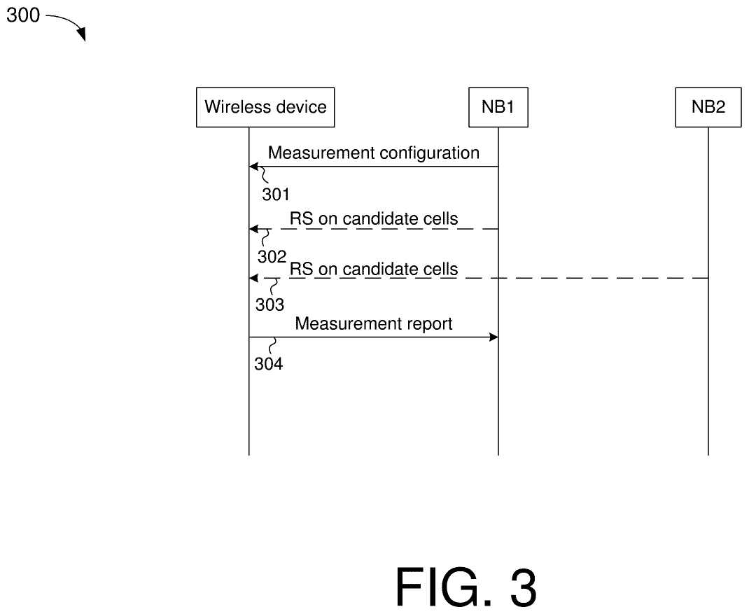

FIG. 3 is a diagram of a proposed procedure 300 during a handover for a wireless device 120 in accordance an implementation of the present disclosure. In some implementations, as shown in step 301 of FIG. 3, the wireless device 120 may receive a measurement configuration for detection of candidate cells from a serving cell NB1 that is configured to the UE 130. In steps 302 and 303, the wireless device 120 may receive a reference signal (RS) on the candidate cells from the serving cells NB1 and from other cell(s)/BS(s) (e.g., NB2). In step 304, the wireless device 120 may transmit a measurement report to the serving cell NB1. Specifically, the measurement configuration and/or the measurement report may include a configuration for the wireless device 120 to indicate the serving cell NB1 device-collaboration transmissions between the wireless device 120 and the UE 130.

In some implementations, as shown in FIG. 1, the UE 130 may determine a first RSRP measurement result by receiving a first RS from the BS 110 in the first CC (e.g., CC1), and may further determine a second RSRP measurement result by receiving a second RS from the wireless device 120 in the second CC (e.g., CC2). As that, the UE 130 may perform the cell selection based on the first RSRP measurement result and the second RSRP measurement result. Specifically, the first CC (e.g., CC1) and the second CC (e.g., CC2) are not overlapped in a frequency domain. Also, the BS 110 may adaptively configure a resource and/or indication to the UE 130 to inform the UE 130 that there is a second RS to be received by the wireless device 120 in the first CC (e.g., CC1) and to be forwarded to the UE in the second CC (e.g., CC2).

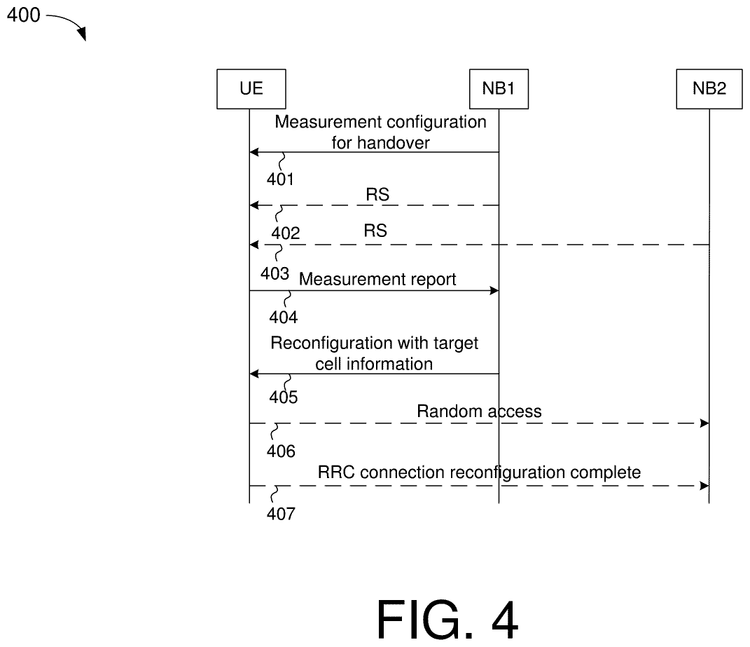

FIG. 4 is a diagram of a proposed procedure 400 during a network-initiated handover for a UE in accordance an implementation of the present disclosure. In some implementations, as shown in FIG. 4, the network-initiated handover may be performed while the UE 130 performs the cell selection during the device collaboration. Specifically, in step 401, the UE 130 may receive a measurement configuration for handover from its serving cell NB1. In steps 402 and 403, the UE 130 may receive a RS from the serving cells NB1 and from other cell(s)/BS(s) (e.g., NB2). In step 404, the UE 130 may transmit a measurement report to the serving cell NB1. In one example, the measurement configuration of the procedure 400 may include a configuration for the first CC (e.g., CC1) and the second CC (e.g., CC2), and the measurement report of the procedure 400 may include a measurement for the first CC (e.g., CC1) and the second CC (e.g., CC2).

Next, in step 405, the serving cell NB1 may transmit a reconfiguration with target cell information to the UE 130. In step 406, the UE 130 may transmit a random access to a target cell (e.g., NB2) for performing a handover to the target cell after receiving the reconfiguration from the serving cell NB1. In step 407, the UE may transmit a radio resource control (RRC) connection reconfiguration complete to the target cell (e.g., NB2) to inform the completion of the handover.

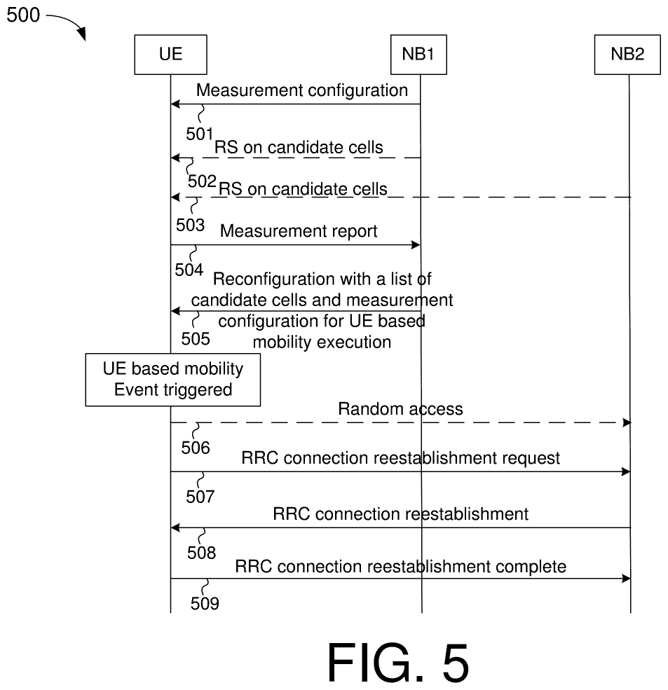

FIG. 5 is a diagram of a proposed procedure 500 during a UE-initiated handover for a UE in accordance an implementation of the present disclosure. In some implementations, as shown in FIG. 5, the UE-initiated handover may be performed while the UE 130 performs the cell selection during the device collaboration. Similar to procedure 400, in step 501 of procedure 500, the UE 130 may receive a measurement configuration for detection of candidate cells from its serving cell NB1. In steps 502 and 503, the UE 130 may receive a RS on candidate cells from the serving cells NB1 and from other cell(s)/BS(s) (e.g., NB2). In step 504, the UE 130 may transmit a measurement report to the serving cell NB1. In one example, the measurement configuration of the procedure 500 may include a configuration for the first CC (e.g., CC1) and the second CC (e.g., CC2), and the measurement report of the procedure 500 may include a measurement for the first CC (e.g., CC1) and the second CC (e.g., CC2).

Next, in step 505, the serving cell NB1 may transmit a reconfiguration with a list of candidate cells and measurement configuration for UE based mobility execution to the UE 130. After triggering a UE based mobility event, in step 506, the UE 130 may transmit a random access to one best candidate cell (e.g., NB2) as the target cell of a handover. In step 507, the UE may transmit an RRC connection reestablishment request to the target cell (e.g., NB2). In step 508, the target cell (e.g., NB2) may transmit an RRC connection reestablishment to the UE 130. In response, in step 509, the UE 130 may transmit an RRC connection reestablishment complete to the target cell (e.g., NB2) to inform the completion of the handover.

Based on the above proposals via the direct link or the indirect link, the UE may receive one additional RSRP measurement result from the wireless device (e.g., repeater), which is associated with the UE for the device collaboration, and may determine its own RSRP measurement result before performing the cell selection. Since the UE may adaptively consider two RSRP measurement results/lists indicating a plurality of RSRP values transmitted from all candidate cell(s) to the UE as well as to the wireless device before the UE performs the cell selection to determine its serving cell from the candidate cell(s), the issue of inconsistent serving cell between the UE and the wireless device may be overcome by adaptively selecting the serving cell for the UE. Also, it is proposed the measurement configuration and the measurement report for the UE as well as the wireless device to perform the corresponding handover procedure during the device collaboration. Thus, an adaptive selection of one serving cell for the UE undergoing the device collaboration with the wireless device is proposed.

### Illustrative Implementations

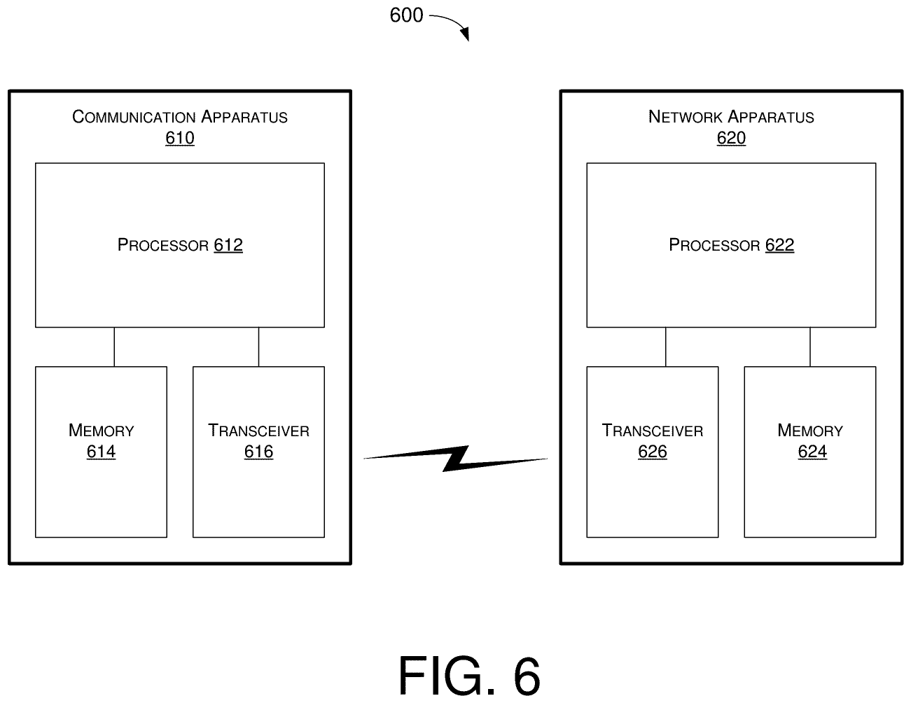

FIG. 6 illustrates an example communication system 600 having at least an example communication apparatus 610 and an example network apparatus 620 in accordance with an implementation of the present disclosure. Each of apparatus 610 and apparatus 620 may perform various functions to implement schemes, techniques, processes and methods described herein pertaining to a UE performing a cell selection during device collaboration with a wireless device, including the various schemes described above with respect to various proposed designs, concepts, schemes, systems and methods described above, including network scheme 100, as well as processes described below.

Each of apparatus 610 and apparatus 620 may be a part of an electronic apparatus, which may be a network apparatus or a UE (e.g., UE 130), such as a portable or mobile apparatus, a wearable apparatus, a vehicular device or a vehicle, a wireless communication apparatus or a computing apparatus. For instance, each of apparatus 610 and apparatus 620 may be implemented in a smartphone, a smart watch, a personal digital assistant, an electronic control unit (ECU) in a vehicle, a digital camera, or a computing equipment such as a tablet computer, a laptop computer or a notebook computer. Each of apparatus 610 and apparatus 620 may also be a part of a machine type apparatus, which may be an IoT apparatus such as an immobile or a stationary apparatus, a home apparatus, a roadside unit (RSU), a wire communication apparatus or a computing apparatus. For instance, each of apparatus 610 and apparatus 620 may be implemented in a smart thermostat, a smart fridge, a smart door lock, a wireless speaker or a home control center. When implemented in or as a network apparatus, apparatus 610 and/or apparatus 620 may be implemented in an eNodeB in an LTE, LTE-Advanced or LTE-Advanced Pro network or in a gNB, a repeater (e.g., NCR) or TRP in a 5G network, an NR network or an IoT network.

In some implementations, each of apparatus 610 and apparatus 620 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, each of apparatus 610 and apparatus 620 may be implemented in or as a network apparatus or a UE. Each of apparatus 610 and apparatus 620 may include at least some of those components shown in FIG. 6 such as a processor 612 and a processor 622, respectively, for example. Each of apparatus 610 and apparatus 620 may further include one or more other components not pertinent to the proposed scheme of the present disclosure (e.g., internal power supply, display device and/or user interface device), and, thus, such component(s) of apparatus 610 and apparatus 620 are neither shown in FIG. 6 nor described below in the interest of simplicity and brevity.

In one aspect, each of processor 612 and processor 622 may be implemented in the form of one or more single-core processors, one or more multi-core processors, or one or more CISC or RISC processors. That is, even though a singular term “a processor” is used herein to refer to processor 612 and processor 622, each of processor 612 and processor 622 may include multiple processors in some implementations and a single processor in other implementations in accordance with the present disclosure. In another aspect, each of processor 612 and processor 622 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 612 and processor 622 is a special-purpose machine specifically designed, arranged and configured to perform specific tasks including those pertaining to a UE performing a cell selection during device collaboration with a wireless device in accordance with various implementations of the present disclosure.

In some implementations, apparatus 610 may also include a transceiver 616 coupled to processor 612. Transceiver 616 may be capable of wirelessly transmitting and receiving data. In some implementations, transceiver 616 may be capable of wirelessly communicating with different types of wireless networks of different radio access technologies (RATs). In some implementations, transceiver 616 may be equipped with a plurality of antenna ports (not shown) such as, for example, four antenna ports. That is, transceiver 616 may be equipped with multiple transmit antennas and multiple receive antennas for multiple-input multiple-output (MIMO) wireless communications. In some implementations, apparatus 620 may also include a transceiver 626 coupled to processor 622. Transceiver 626 may include a transceiver capable of wirelessly transmitting and receiving data. In some implementations, transceiver 626 may be capable of wirelessly communicating with different types of UEs/wireless networks of different RATs. In some implementations, transceiver 626 may be equipped with a plurality of antenna ports (not shown) such as, for example, four antenna ports. That is, transceiver 626 may be equipped with multiple transmit antennas and multiple receive antennas for MIMO wireless communications.

In some implementations, apparatus 610 may further include a memory 614 coupled to processor 612 and capable of being accessed by processor 612 and storing data therein. In some implementations, apparatus 620 may further include a memory 624 coupled to processor 622 and capable of being accessed by processor 622 and storing data therein. Each of memory 614 and memory 624 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 614 and memory 624 may include a type of read-only memory (ROM) such as mask ROM, programmable ROM (PROM), erasable programmable ROM (EPROM) and/or electrically erasable programmable ROM (EEPROM). Alternatively, or additionally, each of memory 614 and memory 624 may include a type of non-volatile random-access memory (NVRAM) such as flash memory, solid-state memory, ferroelectric RAM (FeRAM), magnetoresistive RAM (MRAM) and/or phase-change memory. Alternatively, or additionally, each of memory 614 and memory 624 may include a U ICC.

Each of apparatus 610 and apparatus 620 may be a communication entity capable of communicating with each other using various proposed schemes in accordance with the present disclosure. For illustrative purposes and without limitation, a description of capabilities of apparatus 610, as a UE (e.g., UE 130) and/or a wireless device 120 (e.g., repeater 120), and apparatus 620, as a network node (e.g., BS 110) of a wireless network, is provided below.

Under certain proposed schemes in accordance with the present disclosure with respect to a UE performing a cell selection during device collaboration with a wireless device in mobile communications, processor 612 of apparatus 610, implemented in or as UE 130, may receiving, via transceiver 616, an RSRP measurement result from a wireless device (e.g., repeater 120) or from a network node (e.g., BS 110) of a wireless network, where the RSRP measurement result may include a first list indicating at least one RSRP transmitted from at least one candidate cell to the wireless device (e.g., repeater 120). Additionally, processor 612 may perform a cell selection based on at least one of the first list and a second list, where the second list may indicate at least one RSRP transmitted from the at least one candidate cell to the apparatus (e.g., UE 130). Additionally, processor 612 may determine a serving cell from the at least one candidate cell based on the cell selection.

In some implementations, in an event that the apparatus (e.g., UE 130) receives the RSRP measurement result from the wireless device (e.g., repeater 120), processor 612 may select a first cell from the at least one candidate cell to be the serving cell, where the first cell may correspond to a maximum RSRP in the first list. Alternatively, processor 612 may also select a second cell from the at least one candidate cell to be the serving cell, where the second cell may correspond to a maximum RSRP in the second list. Alternatively, processor 612 may also select a third cell from the at least one candidate cell to be the serving cell, where the third cell may correspond to a maximum sum value determined by the first list and the second list.

In some implementations, in an event that the apparatus (e.g., UE 130) receives the RSRP measurement result from the network node (e.g., BS 110), the RSRP measurement result may be originated from the wireless device (e.g., repeater 120) to the apparatus (e.g., UE 130) via an indirect link.

In some implementations, processor 612 may determine a first RSRP measurement result by receiving a first RS from the network node (e.g., repeater 120) in a first CC, determine a second RSRP measurement result by receiving a second RS from the wireless device (e.g., repeater 120) in a second CC, and perform the cell selection based on the first RSRP measurement result and the second RSRP measurement result, where the first CC and the second CC may not be overlapped in a frequency domain.

In some implementations, processor 612 may receive a measurement configuration from the network node (e.g., BS 110), transmit a measurement report to the network node (e.g., BS 110), and perform a handover to a target cell after receiving a reconfiguration from the network node (e.g., BS 110). The measurement configuration may include a configuration for the first CC and the second CC, and the measurement report may include a measurement for the first CC and the second CC.

In some implementations, the apparatus (e.g., UE 130) may be associated with the wireless device (e.g., repeater 120) for device collaboration.

Under other proposed schemes in accordance with the present disclosure with respect to a UE performing a cell selection during device collaboration with a wireless device, processor 612 of apparatus 610, implemented in or as repeater 120, may determine an RSRP measurement result including a first list indicating at least one RSRP transmitted from at least one candidate cell to the wireless device (e.g., repeater 120). In addition, processor 612 may transmit the RSRP measurement result to an apparatus (e.g., UE 130) or to a network node (e.g., BS 110) of a wireless network before the apparatus (e.g., UE 130) performs a cell selection.

In some implementations, in an event that the wireless device (e.g., repeater 120) transmits the RSRP measurement result to the network node (e.g., BS 110), the apparatus (e.g., UE) may receive the RSRP measurement result from the network node (e.g., BS 110) before performing the cell selection.

In some implementations, processor 612 may receive a measurement configuration from the network node (e.g., BS 110) and transmit a measurement report to the network node (e.g., BS 110). The measurement report may include a configuration indicating device collaboration between the wireless device (e.g., repeater 120) and the apparatus (e.g., UE 130).

In some implementations, processor 612 may receive a RS from the network node (e.g., BS 110) in a first CC and transmit the RS to the apparatus (e.g., UE 130) in a second CC. The first CC and the second CC may not be overlapped in a frequency domain.

In some implementations, the wireless device (e.g., repeater 120) may be associated with the apparatus (e.g., UE 130) for device collaboration.

Under other proposed schemes in accordance with the present disclosure with respect to a UE performing a cell selection during device collaboration with a wireless device, processor 622 of apparatus 620, implemented in or as BS 110, may receive an RSRP measurement result from a wireless device (e.g., repeater 120), where the RSRP measurement result may include a first list indicating at least one RSRP transmitted from at least one candidate cell to the wireless device (e.g., repeater 120). In addition, processor 622 may transmit the RSRP measurement result to an apparatus (e.g., UE 130) before the apparatus (e.g., UE 130) performs a cell selection.

In some implementations, process 900 may involve processor 622 transmitting a RS to the apparatus (e.g., UE 130) in a first CC before the apparatus (e.g., UE 130) determines a first RSRP measurement result.

In some implementations, processor 622 may transmit a measurement configuration to the apparatus (e.g., UE 130), receive a measurement report from the apparatus (e.g., UE 130), and transmit a reconfiguration to the apparatus (e.g., UE 130) for the apparatus (e.g., UE 130) performing a handover to a target cell.

In some implementations, processor 622 may transmit a measurement configuration to the wireless device (e.g., repeater 120) and receive a measurement report from the wireless device (e.g., repeater 120), where the measurement report may include a configuration indicating device collaboration between the wireless device (e.g., repeater 120) and the apparatus (e.g., UE 130).

### Illustrative Processes

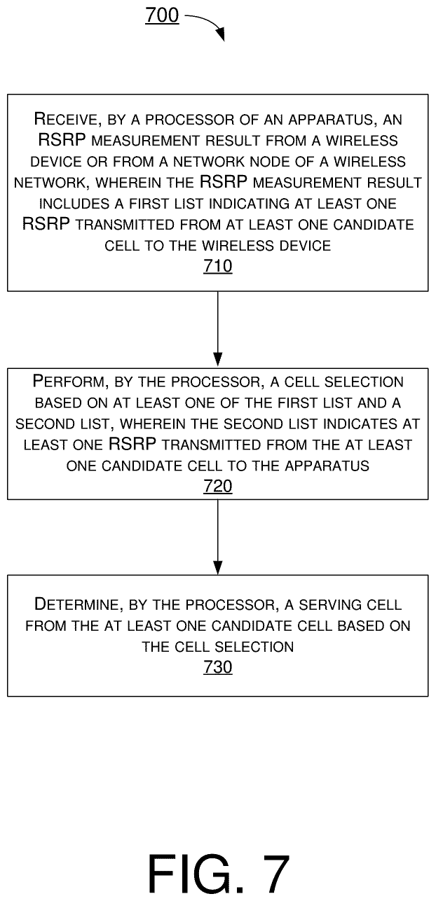

FIG. 7 illustrates an example process 700 in accordance with an implementation of the present disclosure. Process 700 may represent an aspect of implementing various proposed designs, concepts, schemes, systems and methods described above, whether partially or entirely, including those described above. More specifically, process 700 may represent an aspect of the proposed concepts and schemes pertaining to a UE performing a cell selection during device collaboration with a wireless device. Process 700 may include one or more operations, actions, or functions as illustrated by one or more of blocks 710 to 730. Although illustrated as discrete blocks, various blocks of process 700 may be divided into additional blocks, combined into fewer blocks, or eliminated, depending on the desired implementation. Moreover, the blocks/sub-blocks of process 700 may be executed in the order shown in FIG. 7 or, alternatively in a different order. Furthermore, one or more of the blocks/sub-blocks of process 700 may be executed iteratively. Process 700 may be implemented by or in apparatus 610 and apparatus 620 as well as any variations thereof. Solely for illustrative purposes and without limiting the scope, process 700 is described below in the context of apparatus 610 as a UE (e.g., UE 130) or a wireless device (e.g., repeater 120) and apparatus 620 as a communication entity such as a network node or base station (e.g., BS 110) of a wireless network. Process 700 may begin at block 710.

At 710, process 700 may involve processor 612 of apparatus 610, implemented in or as UE 130, receiving, via transceiver 616, an RSRP measurement result from a wireless device (e.g., repeater 120) or from a network node (e.g., BS 110) of a wireless network, where the RSRP measurement result may include a first list indicating at least one RSRP transmitted from at least one candidate cell to the wireless device (e.g., repeater 120). Process 700 may proceed from 710 to 720.

At 720, process 700 may involve processor 612 performing a cell selection based on at least one of the first list and a second list, where the second list may indicate at least one RSRP transmitted from the at least one candidate cell to the apparatus (e.g., UE 130). Process 700 may proceed from 720 to 730.

At 730, process 700 may involve processor 612 determining a serving cell from the at least one candidate cell based on the cell selection.

In some implementations, in an event that the apparatus (e.g., UE 130) receives the RSRP measurement result from the wireless device (e.g., repeater 120), process 700 may involve processor 612 selecting a first cell from the at least one candidate cell to be the serving cell, where the first cell may correspond to a maximum RSRP in the first list. Alternatively, process 700 may involve processor 612 selecting a second cell from the at least one candidate cell to be the serving cell, where the second cell may correspond to a maximum RSRP in the second list. Alternatively, process 700 may involve processor 612 selecting a third cell from the at least one candidate cell to be the serving cell, where the third cell may correspond to a maximum sum value determined by the first list and the second list.

In some implementations, in an event that the apparatus (e.g., UE 130) receives the RSRP measurement result from the network node (e.g., BS 110), the RSRP measurement result may be originated from the wireless device (e.g., repeater 120) to the apparatus (e.g., UE 130) via an indirect link.

In some implementations, process 700 may further involve processor 612 determining a first RSRP measurement result by receiving a first RS from the network node (e.g., BS 110) in a first CC, determining a second RSRP measurement result by receiving a second RS from the wireless device (e.g., repeater 120) in a second CC, and performing the cell selection based on the first RSRP measurement result and the second RSRP measurement result. The first CC and the second CC may not be overlapped in a frequency domain.

In some implementations, process 700 may further involve processor 612 receiving a measurement configuration from the network node (e.g., BS 110), transmitting a measurement report to the network node (e.g., BS 110), and performing a handover to a target cell after receiving a reconfiguration from the network node (e.g., BS 110). The measurement configuration may include a configuration for the first CC and the second CC, and the measurement report may include a measurement for the first CC and the second CC.

In some implementations, the apparatus (e.g., UE 130) may be associated with the wireless device (e.g., repeater 120) for device collaboration.

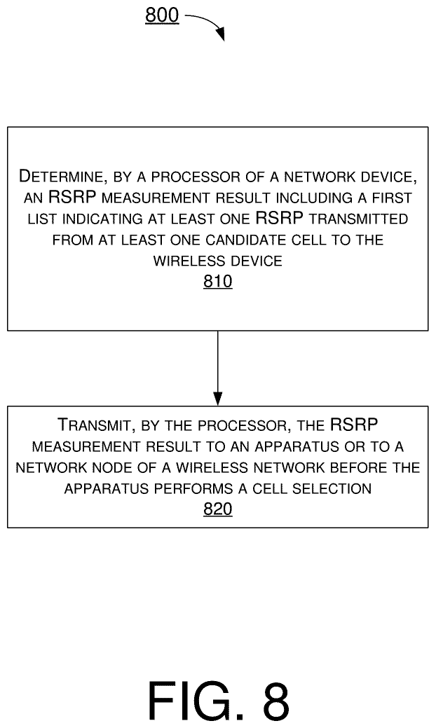

FIG. 8 illustrates another example process 800 in accordance with an implementation of the present disclosure. Process 800 may represent an aspect of implementing various proposed designs, concepts, schemes, systems and methods described above, whether partially or entirely, including those described above. More specifically, process 800 may represent an aspect of the proposed concepts and schemes pertaining to a UE performing a cell selection during device collaboration with a wireless device. Process 800 may include one or more operations, actions, or functions as illustrated by block 810 to 820. Although illustrated as discrete blocks, various block of process 800 may be divided into additional blocks, combined into fewer blocks, or eliminated, depending on the desired implementation. Moreover, the blocks/sub-blocks of process 800 may be executed in the order shown in FIG. 8 or, alternatively in a different order. Furthermore, one or more of the blocks/sub-blocks of process 800 may be executed iteratively. Process 800 may be implemented by or in apparatus 610 and apparatus 620 as well as any variations thereof. Solely for illustrative purposes and without limiting the scope, process 800 is described below in the context of apparatus 610 as a wireless device (e.g., repeater 120) or a UE (e.g., UE 130) and apparatus 620 as a communication entity such as a network node or base station (e.g., BS 110) of a wireless network. Process 800 may begin at block 810.

At 810, process 800 may involve processor 612 of apparatus 610, implemented in or as wireless device (e.g., repeater 120), determining an RSRP measurement result including a first list indicating at least one RSRP transmitted from at least one candidate cell to the wireless device (e.g., repeater 120). Process 800 may proceed from 810 to 820.

At 820, process 800 may involve processor 612 transmitting the RSRP measurement result to an apparatus (e.g., UE 130) or to a network node (e.g., BS 110) of a wireless network before the apparatus (e.g., UE 130) performs a cell selection.

In some implementations, in an event that the wireless device (e.g., repeater 120) transmits the RSRP measurement result to the network node (e.g., BS 110), the apparatus (e.g., UE 130) may receive the RSRP measurement result from the network node (e.g., BS 110) before performing the cell selection.

In some implementations, process 800 may involve processor 612 receiving a measurement configuration from the network node (e.g., BS 110), and transmitting a measurement report to the network node (e.g., BS 110). The measurement report may include a configuration indicating device collaboration between the wireless device (e.g., repeater 120) and the apparatus (e.g., UE).

In some implementations, process 800 may involve processor 612 receiving a RS from the network node (e.g., BS 110) in a first CC, and transmitting the RS to the apparatus (e.g., UE 130) in a second CC. The first CC and the second CC may not be overlapped in a frequency domain.

In some implementations, the wireless device (e.g., repeater 110) may be associated with the apparatus (e.g., UE 130) for device collaboration.

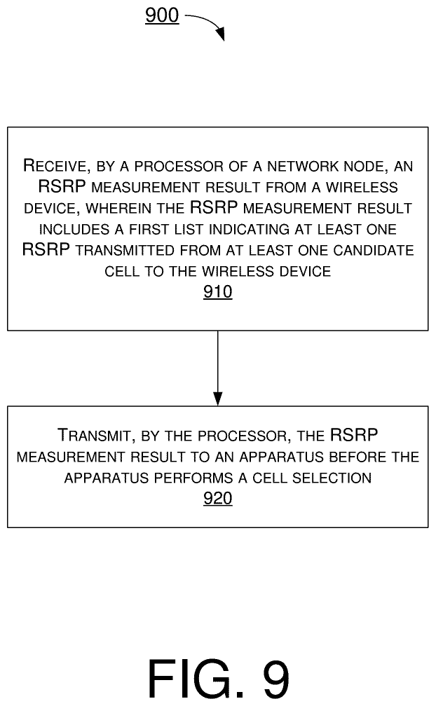

FIG. 9 illustrates another example process 900 in accordance with an implementation of the present disclosure. Process 900 may represent an aspect of implementing various proposed designs, concepts, schemes, systems and methods described above, whether partially or entirely, including those described above. More specifically, process 900 may represent an aspect of the proposed concepts and schemes pertaining to a UE performing a cell selection during device collaboration with a wireless device. Process 900 may include one or more operations, actions, or functions as illustrated by block 910 to 920. Although illustrated as discrete blocks, various block of process 900 may be divided into additional blocks, combined into fewer blocks, or eliminated, depending on the desired implementation. Moreover, the blocks/sub-blocks of process 900 may be executed in the order shown in FIG. 9 or, alternatively in a different order. Furthermore, one or more of the blocks/sub-blocks of process 900 may be executed iteratively. Process 900 may be implemented by or in apparatus 610 and apparatus 620 as well as any variations thereof. Solely for illustrative purposes and without limiting the scope, process 900 is described below in the context of apparatus 610 as a UE (e.g., UE 130) or a wireless device (e.g., repeater 120) and apparatus 620 as a communication entity such as a network node or base station (e.g., BS 110) of a network. Process 900 may begin at block 910.

At 910, process 900 may involve processor 622 of apparatus 620, implemented in or as BS 110, receiving an RSRP measurement result from a wireless device (e.g., repeater 120), where the RSRP measurement result may include a first list indicating at least one RSRP transmitted from at least one candidate cell to the wireless device. Process 900 may proceed from 910 to 920.

At 920, process 900 may involve processor 622 transmitting the RSRP measurement result to an apparatus (e.g., UE 130) before the apparatus (e.g., UE 130) performs a cell selection.

In some implementations, process 900 may involve processor 622 transmitting a RS to the apparatus (e.g., UE 130) in a first CC before the apparatus (e.g., UE 130) determines a first RSRP measurement result.

In some implementations, process 900 may involve processor 622 transmitting a measurement configuration to the apparatus (e.g., UE 130), receiving a measurement report from the apparatus (e.g., UE 130), and transmitting a reconfiguration to the apparatus (e.g., UE 130) for the apparatus (e.g., UE 130) performing a handover to a target cell.

In some implementations, process 900 may involve processor 622 transmitting a measurement configuration to the wireless device (e.g., repeater 120), and receiving a measurement report from the wireless device (e.g., repeater 120). The measurement report may include a configuration indicating device collaboration between the wireless device (e.g., repeater 120) and the apparatus (e.g., UE 130).

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus, a reference signal received power (RSRP) measurement result from a wireless device or from a network node of a wireless network, wherein the RSRP measurement result comprises a first list indicating at least one RSRP transmitted from at least one candidate cell to the wireless device;
performing, by the processor, a cell selection based on at least one of the first list and a second list, wherein the second list indicates at least one RSRP transmitted from the at least one candidate cell to the apparatus; and
determining, by the processor, a serving cell from the at least one candidate cell based on the cell selection.

2. The method of claim 1, wherein in an event that the apparatus receives the RSRP measurement result from the wireless device, the method further comprising:
selecting, by the processor, a first cell from the at least one candidate cell to be the serving cell, wherein the first cell corresponds to a maximum RSRP in the first list;
selecting, by the processor, a second cell from the at least one candidate cell to be the serving cell, wherein the second cell corresponds to a maximum RSRP in the second list; or
selecting, by the processor, a third cell from the at least one candidate cell to be the serving cell, wherein the third cell corresponds to a maximum sum value determined by the first list and the second list.

3. The method of claim 1, wherein in an event that the apparatus receives the RSRP measurement result from the network node, the RSRP measurement result is originated from the wireless device to the apparatus via an indirect link.

4. The method of claim 1, further comprising:
determining, by the processor, a first RSRP measurement result by receiving a first reference signal (RS) from the network node in a first component carrier (CC);
determining, by the processor, a second RSRP measurement result by receiving a second RS from the wireless device in a second CC; and
performing, by the processor, the cell selection based on the first RSRP measurement result and the second RSRP measurement result,
wherein the first CC and the second CC are not overlapped in a frequency domain.

5. The method of claim 4, further comprising:
receiving, by the processor, a measurement configuration from the network node;
transmitting, by the processor, a measurement report to the network node; and
performing, by the processor, a handover to a target cell after receiving a reconfiguration from the network node;
wherein the measurement configuration comprises a configuration for the first CC and the second CC, and the measurement report comprises a measurement for the first CC and the second CC.

6. The method of claim 1, wherein the apparatus is associated with the wireless device for device collaboration.

7. A method, comprising:
determining, by a processor of a wireless device, a reference signal received power (RSRP) measurement result comprising a first list indicating at least one RSRP transmitted from at least one candidate cell to the wireless device; and
transmitting, by the processor, the RSRP measurement result to an apparatus or to a network node of a wireless network before the apparatus performs a cell selection.

8. The method of claim 7, wherein in an event that the wireless device transmits the RSRP measurement result to the network node, the apparatus receives the RSRP measurement result from the network node before performing the cell selection.

9. The method of claim 8, further comprising:
receiving, by the processor, a measurement configuration from the network node; and
transmitting, by the processor, a measurement report to the network node,
wherein the measurement report comprises a configuration indicating device collaboration between the wireless device and the apparatus.

10. The method of claim 7, further comprising:
receiving, by the processor, a reference signal (RS) from the network node in a first component carrier (CC); and
transmitting, by the processor, the RS to the apparatus in a second CC,
wherein the first CC and the second CC are not overlapped in a frequency domain.

11. The method of claim 7, wherein the wireless device is associated with the apparatus for device collaboration.

12. An apparatus implementable in a user equipment (UE), comprising:
a transceiver configured to communicate wirelessly; and
a processor coupled to the transceiver and configured to perform, via the transceiver, operations comprising:
receiving, via the transceiver, a reference signal received power (RSRP) measurement result from a wireless device or from a network node of a wireless network, wherein the RSRP measurement result comprises a first list indicating at least one RSRP transmitted from at least one candidate cell to the wireless device;
performing a cell selection based on at least one of the first list and a second list, wherein the second list indicates at least one RSRP transmitted from the at least one candidate cell to the apparatus; and
determining a serving cell from the at least one candidate cell based on the cell selection.

13. The apparatus of claim 12, wherein in an event that the apparatus receives the RSRP measurement result from the wireless device, the processor is further configured to perform operations comprising:
selecting a first cell from the at least one candidate cell to be the serving cell, wherein the first cell corresponds to a maximum RSRP in the first list;
selecting a second cell from the at least one candidate cell to be the serving cell, wherein the second cell corresponds to a maximum RSRP in the second list; or
selecting a third cell from the at least one candidate cell to be the serving cell, wherein the third cell corresponds to a maximum sum value determined by the first list and the second list.

14. The apparatus of claim 12, wherein in an event that the apparatus receives the RSRP measurement result from the network node, the RSRP measurement result is originated from the wireless device to the apparatus via an indirect link.

15. The apparatus of claim 12, the processor is further configured to perform operations comprising:
determining a first RSRP measurement result by receiving a first reference signal (RS) from the network node in a first component carrier (CC);
determining a second RSRP measurement result by receiving a second RS from the wireless device in a second CC; and
performing the cell selection based on the first RSRP measurement result and the second RSRP measurement result,
wherein the first CC and the second CC are not overlapped in a frequency domain.

16. The apparatus of claim 15, the processor is further configured to perform operations comprising:
receiving a measurement configuration from the network node;
transmitting a measurement report to the network node; and
performing a handover to a target cell after receiving a reconfiguration from the network node;
wherein the measurement configuration comprises a configuration for the first CC and the second CC, and the measurement report comprises a measurement for the first CC and the second CC.

17. The apparatus of claim 12, wherein the apparatus is associated with the wireless device for device collaboration.
